(19) United States
(12) Patent Application Publication
(10) Pub. No.: US 2019/0287012 A1
(43) Pub. Date: Sep. 19, 2019

(54) ENCODER-DECODER NETWORK WITH INTERCOMMUNICATING ENCODER AGENTS

(71) Applicant: Microsoft Technology Licensing, LLC, Redmond, WA (US)

(72) Inventors: Fethiye Asli Celikyilmaz, Kirkland, WA (US); Xiaodong He, Redmond, WA (US)

(21) Appl. No.: 15/924,098

(22) Filed: Mar. 16, 2018

(51) Int. Cl. G06N 7/00; G06N 3/08; G06F 17/27

(52) U.S. Cl. CPC G06N 7/005; G06F 17/2785; G06N 3/08

(57) ABSTRACT

An encoder-decoder neural network for sequence-to-sequence mapping tasks, such as, e.g., abstractive summarization, may employ multiple communicating encoder agents to encode multiple respective input sequences that collectively constitute the overall input. The outputs of the encoder agents may be fed into the decoder, which may use an associated attention mechanism to select which encoder agent to pay attention to at each decoding time step. Additional features and embodiments are disclosed.

### TECHNICAL FIELD

The disclosed subject matter relates generally to machine learning, and more specifically to encoder-decoder neural network architectures for sequence generation.

### BACKGROUND

Artificial neural networks with encoder-decoder architecture have been developed for a variety of sequence-to-sequence mapping tasks. In the realm of natural-language processing, for instance, encoder-decoder networks have been used for machine translation, text summarization, and speech recognition; and in the area of image processing, encoder-decoder networks have been applied, for example, to video segmentation (e.g., for self-driving cars) and medical-image reconstruction (e.g., in computed tomography). Generally, in encoder-decoder architectures, a recurrent-neural-network (RNN) decoder generates an output sequence conditioned on an input sequence encoded by the encoder. The encoder may be an RNN like the encoder (as is usually the case in language-related applications). Alternatively, the encoder may be, for example, a convolutional neural network (CNN) (as can be used to encode image input).

Encoder-decoder RNNs have shown promising results on the task of abstractive summarization of texts. In contrast to extractive summarization, where a summary is composed of a subset of sentences or words lifted from the input text as is, abstractive summarization generally involves rephrasing and restructuring sentences to compose a coherent and concise summary. A fundamental challenge in abstractive summarization, however, is that the strong performance that existing encoder-decoder models exhibit on short input texts does not generalize well to longer texts.

### SUMMARY

This summary section is provided to introduce aspects of embodiments in a simplified form, with further explanation of the embodiments following in the detailed description. This summary section is not intended to identify essential or required features of the claimed subject matter, and the particular combination and order of elements listed in this summary section is not intended to provide limitation to the elements of the claimed subject matter.

Disclosed herein is an encoder-decoder neural network that processes input divided into multiple input sequences with multiple respective intercommunicating encoder agents, and uses an attention mechanism to selectively condition generation of the output sequence by the decoder on the outputs of the encoder agents. Also disclosed are systems, methods, and computer-program products for training the encoder-decoder neural network, and using the trained network, for a variety of sequence-to-sequence mapping tasks, including, without limitation, abstractive summarization. Beneficially, by dividing the task of encoding the input between multiple collaborating encoder agents, the proposed encoder-decoder architecture, in conjunction with suitable training, enables the generation of focused and coherent summaries for longer input texts (e.g., texts including more than 800 tokens). Further, outside the realm of text summarization, the use of multiple encoder agents in accordance herewith facilitates seamlessly integrating different input modalities (e.g., text, image, audio, and/or sensor input) in generating the output sequence; this integration may be useful, for instance, in various automation tasks, where the actions taken by a machine (such as a self-driving car) often dependent on multiple diverse input channels.

In more detail, in some embodiments, each encoder agent includes a local encoder layer, followed by a stack of contextual encoder layers that take message vectors computed from the outputs of layers of other encoder agents as input, enabling communication cycles across multiple encoding layers. In this manner, multiple encoder agents can process the multiple input sequences (that collectively constitute the input) each individually, but with global context information received from the other encoder agents. The top-layer output of the encoder agents is delivered to the decoder. The decoder may use a hierarchical attention mechanism to integrate information across multiple encoder agents and, for each encoder agent, across the encoder outputs computed for multiple tokens of the respective input sequence. Further, in applications where the input to the encoder and the output of the decoder correspond to sequences of tokens of the same type (e.g., the words in a given human language), the encoder output may flow into the computation, by the decoder, of an output probability distribution over an extended vocabulary that includes, beyond tokens from a given basic vocabulary, tokens copied from the input sequences to the various encoder agents. Enabling the vocabulary for the output to be extended based on the input facilitates capturing salient features of the input in the output (e.g., by including proper names occurring in an input text in the generated summary) even with a small or moderately sized basic vocabulary, which, in turn, allows for memory and computational-cost savings.

In various embodiments, training employs a mixed training objective with multiple loss terms (e.g., a maximum-likelihood-estimation loss, a reinforcement-learning loss, and/or a task-specific loss such as a semantic-cohesion loss). Jointly optimizing these losses may serve to balance competing goals, which may include, for instance, in the context of text summarization, a focus on the main ideas without inclusion of superfluous detail, coherence and readability, and non-redundancy.

One aspect, in accordance with various embodiments, is directed to a computer-implemented method using one or more hardware processors executing instructions stored in one or more machine-readable media to perform the following operations: dividing input into a plurality of input sequences; processing the plurality of input sequences with a plurality of respective multi-layer neural-network encoder agents to compute a plurality of respective sequences of top-layer hidden-state output vectors; and using a neural-network decoder to generate a sequence of output probability distributions over a vocabulary, the neural-network decoder being conditioned on an agent context vector. Each encoder agent takes, as input to at least one of its layers, a respective message vector computed from hidden-state output vectors of the other ones of the plurality of encoder agents. The agent context vector includes a weighted average of token context vectors for the plurality of encoder agents, and each token context vector, in turn, includes a weighted average of the top-level hidden-state output vectors computed by that encoder agent. The weights in the weighted averages of the token context vectors and the agent context vector are dependent on a hidden state of the neural-network decoder. The weights in the weighted averages of the token context vectors may be token attention distributions computed from the top-layer hidden-state output vectors of the respective encoder agents, and the weights in the weighted average of the agent context vector may be agent attention distributions computed from the token context vectors.

In some embodiments, the vocabulary includes a basic vocabulary and a vocabulary extension derived from the input, and the output probability distributions are weighted averages of agent-specific output probability distributions, each agent-specific output probability distributions being a weighted average of a probability distribution over the basic vocabulary and a probability distribution over a portion of the extension derived from the input sequence processed by the respective encoder agent.

Each encoder agent includes, in some embodiments, a local encoder and a multi-layer contextual encoder. The method includes, in this case, feeding hidden-state output vectors of the local encoder as input to a first layer of the contextual encoder, feeding hidden-state output vectors of each except the last layer of the contextual encoder as input to the next layer of the contextual encoder, and providing, as input to each layer of the contextual encoder, a message vector computed from at least one of the hidden-state output vectors of layers of the contextual encoders of the other encoder agents. The local encoders and the layers of the contextual encoders of the plurality of encoder agents may each be or comprise a bi-directional long short-term memory (LSTM) network. The neural-network decoder may be or include an LSTM network.

In certain embodiments, the input represents a human-language input sequence and the plurality of input sequences represent subsequences collectively constituting the human-language input sequence. The method may further involve generating a summary of the text from the sequence of output probability distributions over the vocabulary. In other embodiments, the input is multi-modal and is divided into the input sequences by input modality.

In another aspect, various embodiments pertain to a system including one or more hardware processors and memory, the memory storing (i) data and program code collectively defining an encoder-decoder neural network, and (ii) program code which, when executed by the one or more hardware processors, causes the encoder-decoder neural network to be trained based on a mixed training objective comprising a plurality of loss terms, such as, e.g., a maximum-likelihood-estimation term in conjunction with a semantic-cohesion loss term and/or a reinforcement-learning loss term. In some embodiments, the program code causing the network to be trained includes instructions to adjust parameters of the encoder-decoder neural network to maximize a likelihood associated with one or more training examples, and thereafter to further adjust the parameters of the encoder-decoder neural network using self-critical reinforcement learning (using, in certain embodiments, intermediate rewards).

The encoder-decoder neural network includes a plurality of intercommunicating multi-layer encoder agents, each encoder agent taking, as input to one or more of its layers, one or more respective message vectors computed from hidden-state output of the other ones of the plurality of encoder agents; and a decoder comprising a recurrent neural network taking, as input at each time step, a respective current decoder state and a context vector computed from top-layer hidden-state outputs of the plurality of encoder agents. The context vector may include a weighted average of token context vectors for the plurality of encoder agents, the token context vector for each of the encoder agents including a weighted average of vectors constituting the top-level hidden-state output computed by that encoder agent, where weights in the weighted averages of the token context vector and the context vector are dependent on a hidden state of the recurrent neural network.

In some embodiment, the decoder is configured to generate a sequence of output probability distributions over a vocabulary. The vocabulary may include, in addition to a basic vocabulary, a vocabulary extension derived from input to the encoder-decoder neural network. The output probability distributions are, in this case, weighted averages of agent-specific output probability distributions, each agent-specific output probability distributions being a weighted average of a probability distribution over the basic vocabulary and a probability distribution over a portion of the extension derived from a portion of the input to the encoder-decoder neural network to be processed by the respective encoder agent.

Yet another aspect, in accordance with various embodiments, pertains to a machine-readable medium (or multiple such media) storing data defining a trained encoder-decoder neural network, and instructions which, when executed by one or more hardware processors, cause the hardware processor(s) to perform operations for generating text output from input to the encoder-decoder neural network. The encoder-decoder neural network includes a plurality of intercommunicating multi-layer encoder agents, each encoder agent taking, as input to one or more of its layers, one or more respective message vectors computed from hidden-state output of the other ones of the plurality of encoder agents, and a decoder comprising a recurrent neural network taking, as input at each time step, a respective current decoder state and a context vector computed from top-layer hidden-state outputs of the plurality of encoder agents. The operations for generating the text output include dividing the input to the encoder-decoder neural network into a plurality of input sequences, feeding the plurality of input sequences into the plurality of encoder agents, using the plurality of encoder agents to encode the input to the encoder-decoder neural network by the top-layer hidden-state output of the plurality of decoder agents, and using the decoder to greedily decode the encoded input to the encoder-decoder neural network to generate a sequence of words selected from a vocabulary, the sequence of words constituting the text output. In some embodiments, the input to the encoder-decoder neural network is human-language input, such as, for example, text input, which may be divided into text sections (corresponding to the input sequences) that collectively constitute the text input. The encoder-decoder neural network may be trained to generate, as the text output, a summary of the text input. The vocabulary may include a basic vocabulary and a vocabulary extension derived from the text input to the encoder-decoder neural network, and the output probability distributions may be weighted averages of agent-specific output probability distributions, each agent-specific output probability distributions being a weighted average of a probability distribution over the basic vocabulary and a probability distribution over a portion of the extension derived from text section processed by the respective encoder agent.

### BRIEF DESCRIPTION OF THE DRAWINGS

The foregoing will be more readily understood from the following detailed description of various embodiments, in particular, when taken in conjunction with the accompanying drawings.

FIG. 1 is a diagram schematically illustrating an encoder-decoder neural network architecture with multiple encoder agents in accordance with various embodiments.

FIG. 2 is a diagram illustrating, in more detail, an unfolded multi-layer encoder agent in accordance with various embodiments.

FIG. 3 is a diagram illustrating, in more detail, message passing between encoder agents in accordance with various embodiments.

FIG. 4 is a diagram illustrating, in more detail, an unfolded decoder with agent attention in accordance with various embodiments.

FIG. 5 is a block diagram of a computing system for implementing an encoder-decoder neural network in accordance with various embodiments.

FIG. 6 is a flow chart of a method for mapping an input sequence to an output sequence using an encoder-decoder neural network in accordance with various embodiments.

FIG. 7 is a flow chart of a method for training an encoder-decoder neural network in accordance with various embodiments.

FIG. 8 is a block diagram of an example computing system as may be used to implement the system of FIG. 5, in accordance with various embodiments.

### DETAILED DESCRIPTION

Described herein is an encoder-decoder artificial neural network model for sequence-to-sequence mapping that distributes the task of encoding the input across multiple collaborating encoder agents (herein also simply “agents”), each in charge of a different portion of the input. In various embodiments, each agent initially encodes its respective assigned input portion independently, and then broadcasts its encoding to other agents, allowing agents to share global context information with one another about the different portions of the input. All agents then adapt the encoding of their assigned input in light of the global context and, in some embodiments, repeat the process across multiple layers, generating new messages at each layer. Once the agents complete encoding, they deliver their information to a decoder with contextual agent attention. Contextual agent attention enables the decoder to integrate information from multiple agents smoothly at each decoding step. The encoder-decoder network can be trained end-to-end, e.g., using self-critical reinforcement learning, as will be described further below.

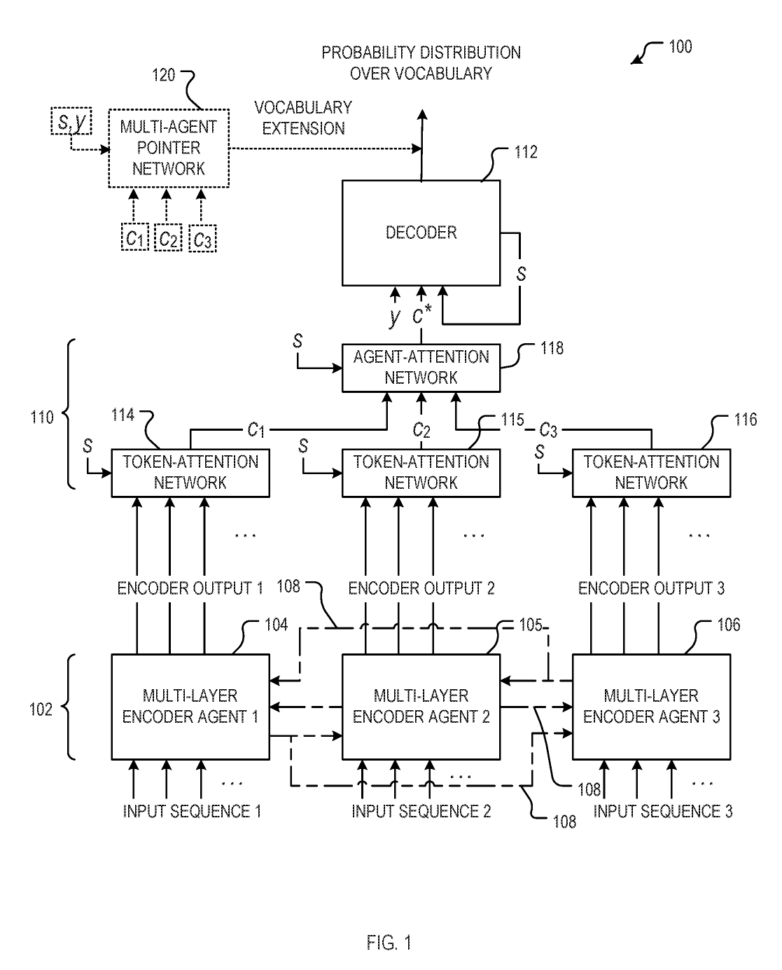

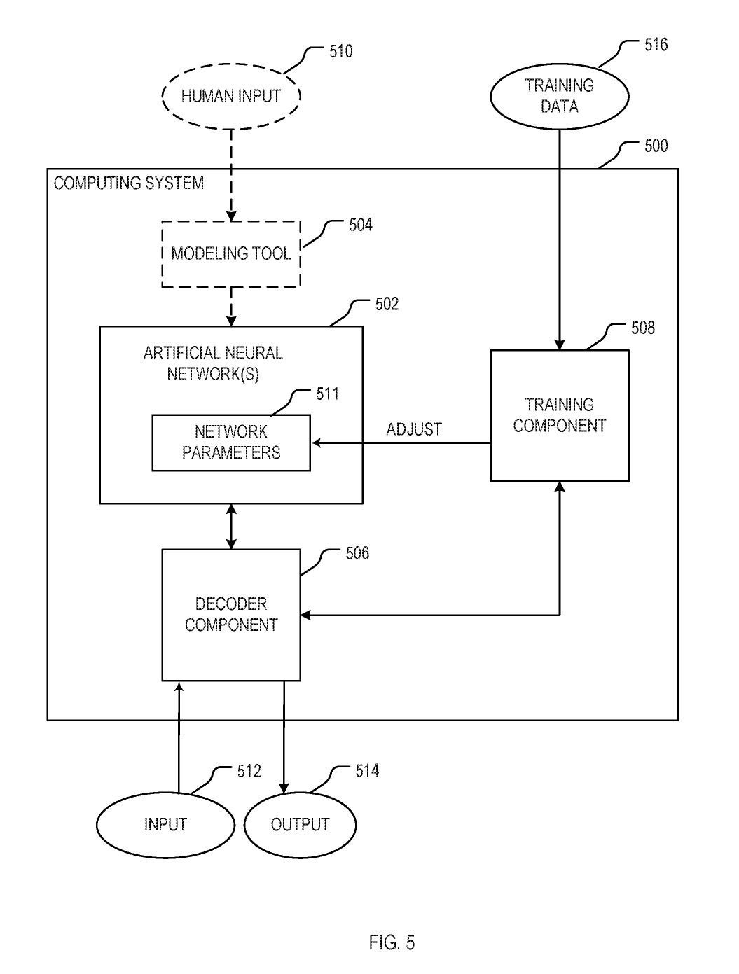

FIG. 1 is a block diagram schematically illustrating an encoder-decoder neural network architecture in accordance with various embodiments (e.g., as implemented using a computing system as described below with reference to FIG. 5). The encoder-decoder neural network 100 includes, in its encoder layer 102, a plurality of multi-layer encoder agents 104, 105, 106, each taking a portion of the input as an input sequence and generating a corresponding encoded sequence as its encoder output. While three encoder agents 104, 105, 106 are depicted, it is to be understood that, in general, any number of two or more agents may be used in the encoder layer 102. The number of encoder agents may be fixed for a given application, or be dynamically adjustable based, e.g., on the length of the input. In the case of multi-modal input, the number of encoder agents may depend on the number of different input modalities. Also depending on the particular application and type of input, the encoder agents may all share the same internal architecture (e.g., the same number and types of layers, and the same connections between layers), or differ in one or more respects. For example, in text summarization, multiple agents of identical architecture may be used to process different sections of the input text. To encode multi-modal input, on the other hand, it may make sense to use different encoder-agent architectures each adjusted to the particular type of input. For example, to encode input including both text and images, one encoder agent may be built from RNNs to encode the text portions, while another encoder may be built from CNNs to encode the images. The input to the multiple encoder agents may be raw input, such as sequences of words in a natural language (or a sequence of vectors trivially mapping on the natural words, such as one-hot vectors whose dimensionality equals the size of the input vocabulary and which each have a single component equal to 1 corresponding to the word they encode, all other components being zero). The first layer of each encoder agent may create an initial embedded representation of such raw input (e.g., a representation with lower-dimensional real-valued vectors). Alternatively, the input to the encoder agents may include or consist of already embedded representations, e.g., as computed by a separate neural network preceding the encoder-decoder neural network 100.

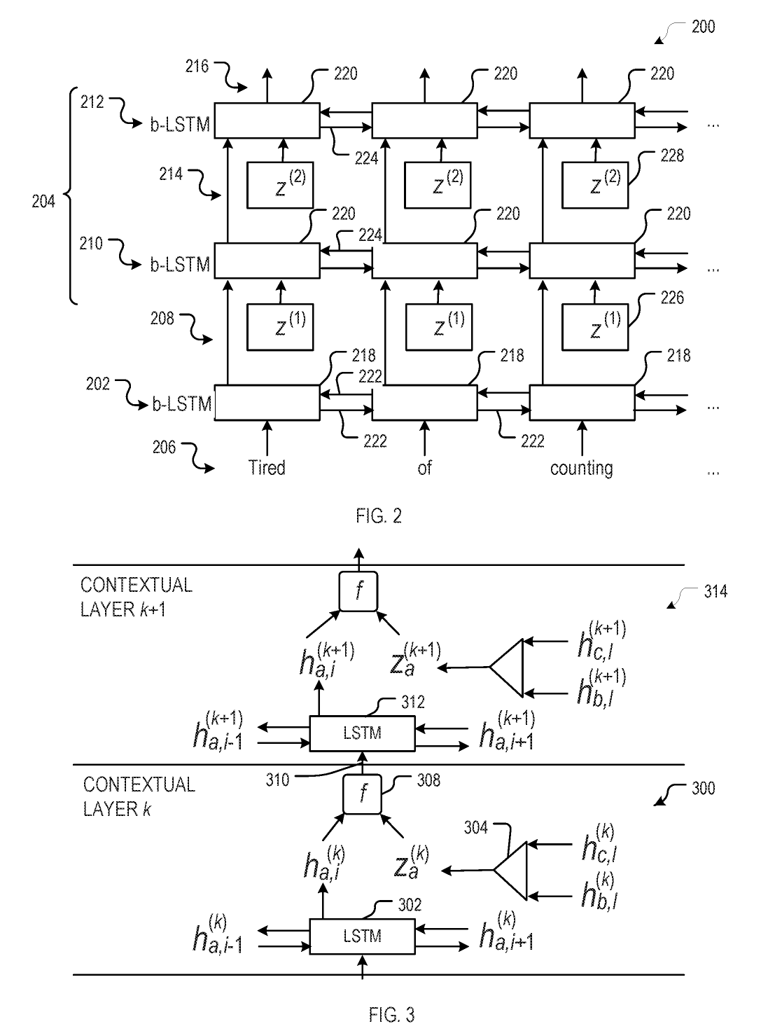

The encoder agents 104, 105, 106 exchange messages 108, depicted in FIG. 1 by dashed arrows, with one another. These messages may take the form of vectors computed from hidden-state output of one or more layers of the respective sending encoder agents and fed as input into one or more layers of the respective receiving encoder agents. For a given pair of a sending agent and a receiving agent, multiple messages (e.g., as explained below with reference to FIG. 2), e.g., corresponding to the outputs at multiple of the layers within the sending encoder agent, may be transmitted. Alternatively, the outputs from multiple layers within the sending encoder agent may be combined into a single message. Further, the message computed from a given layer need not be based on the entirety of the hidden-state output of the layer, which is generally a sequence of hidden-state output vectors corresponding to the tokens in the input sequence, but may generally be computed from any combination of these hidden-state output vectors (such as, e.g., from a single hidden-state output vector), and this combination may be fixed for a given neural network or may be learned during network training. In some embodiments, an attention mechanism is applied over the messages to allow the encoder agents to apply different weights (including zero weights) to the messages from different ones of the other encoder agents, and thereby to decide, at each time step, which of the messages to pay attention to.

The output of the encoder agents 104, 105, 106 is fed, via a hierarchical attention mechanism 110, into the decoder 112. The decoder 112 is generally implemented by an RNN including a softmax layer that sequentially generates, for each token of the output sequence, a probability distribution over the vocabulary, that is, the set of possible output labels (including an end-of-sequence symbol) that each token of the output sequence can take. At each time step, the decoder 112 takes, as inputs, its prior hidden decoder state s (as computed in the previous time step), a context vector c* determined from the encoder outputs, and the previous token y in the output sequence. During supervised network training, when the neural network is used to compute the probability of the “ground-truth” output sequence of a known training pair of input and output sequences, the previous token of the output sequence is taken from the ground-truth output sequence. In the inference phase (or test phase), when no ground truth is available, the previous token of the output sequence is the output token computed by the decoder 112 in the previous time step (which, e.g., in the case of greedy decoding, takes the value that is most probable in the probability distribution output by the decoder 112).

The context vector c* is computed by the hierarchical attention mechanism 110 in a two-layer hierarchy. In the first layer, token-attention networks 114, 115, 116, each associated with one of the encoder agents 104, 105, 106, compute token context vectors c₁, c₂, c₃, which are weighted combinations of the top-layer hidden-state output vectors of the respective encoder agents 104, 105, 106. In the second layer, an agent-attention network 118 computes the context vector c* (herein also the “agent context vector”) as a weighted combination of the token context vectors c₁, c₂, c₃ of all of the encoder agents 104, 105, 106. Both the token-attention networks 114, 115, 116 and the agent-attention network 118 may be feed-forward networks, and take the decoder state s as input.

In some embodiments, the encoder-decoder neural network 100 further includes a multi-agent pointer network 120 that extends the vocabulary from which the decoder selects values for the tokens of the output sequence by including tokens lifted from the input to the encoder agents 104, 105, 106. This additional network component may be useful in applications where the input and output are generally sequences over the same vocabulary (e.g., the vocabulary of a given human language), but where, for purposes of computational tractability, the size of the vocabulary initially used by the decoder is limited to a basic vocabulary of frequently used labels, which may omit key tokens from the input. The probabilities of selecting tokens from the input sequence to the various agents, relative to one another and to the probability of selecting a token from the basic vocabulary, may be computed by the multi-agent pointer network 120 based on the token context vectors c₁, c₂, c₃ (and intermediate computational results of the token-attention networks 114, 115, 116) in conjunction with the hidden decoder state s and the previous output token y.

The encoder layer 102, decoder 112, hierarchical attention mechanism 110, and (optional) multi-agent pointer network 120 are in the following described in more detail, with frequent reference to the example of an encoder-decoder neural network for abstractive text summarization.

FIG. 2 is a diagram illustrating an example multi-layer encoder agent 200 (as may be used for any or all of decoder agent 104, 105, 106) in accordance with various embodiments. The encoder agent 200 includes a local encoder 202 and a contextual encoder 204 stacked above the local encoder 202. The local encoder 202, which may be formed of a single neural-network layer (as shown) or include multiple neural-network layers, performs the first level of encoding on the input 206 to the encoder agent 200, and generates local hidden-state output vectors 208 that are passed on to the contextual encoder 204. The contextual encoder 204 includes one or more neural-network layers; in the illustrated example, two contextual encoder layers 210, 212 are shown, with hidden-state output vectors 214 of layer 210 being passed on as input to layer 212. The top-most of the contextual encoder layers (e.g., as shown, layer 212) generates the final hidden-state (or “top-layer”) output vectors 216 of the encoder agent 200.

Each of the layers of the local encoder 202 and the contextual encoder 204 may be an RNN built, for example, from long short-term memory (LSTM) units or gated recurrent units (GRUs), or from other types of neural-network units. In general, RNNs sequentially process input, feeding the hidden state computed at each time step back into the RNN for the next time step. They are, thus, suitable for encoding sequential input in a manner that takes, during the encoding of any token within the input sequence, the context of preceding tokens into account. In certain embodiments, the local encoder and contextual encoder layers 202, 210, 212 are each bi-directional LSTMs, which process the input sequence 206 in both directions (from left to right and from right to left) to encode each token based on the context of both preceding and following tokens in the sequence 206.

In FIG. 2, the bidirectional LSTMs (“b-LSTMs”) are depicted “unfolded,” that is, showing the network at different time steps as separate cells 218, 220 (for the local encoder 202 and contextual encoder 204, respectively) with arrows 222, 224 (only some of which being labeled to avoid cluttering of the figure) indicating the flow of hidden-state information between cells 218, 220, respectively. As can be seen, in the unfolded bidirectional LSTMs, each cell processes one of the tokens of the input sequence, passing its output on to the corresponding cell of the next-higher layer. For example, the token “Tired” is fed into the left-most cell 218 of the local encoder 202, which passes its hidden-state output vector 208 as input to the left-most cell 220 of the first contextual encoder layer 210. The hidden-state output vector 214 of the left-most cell 220 of the first contextual encoder layer 210, in turn, is fed into the left-most cell of the second contextual encoder layer 212, which then produces the final hidden-state output vector 216 encoding the token “Tired.” The other tokens are processed similarly, such that the input sequence 206 is encoded in a same-length sequence of top-layer hidden state output vectors 216.

In accordance herewith, the multiple encoder agents 104, 105, 106 (e.g., as implemented by encoder agent 200) share information about the respective input sequence they encode via messages. At the input of a given contextual encoder layer of the encoder agent 200, a message vector z^{(k)} (labeled 226 for layer 210 and 228 for layer 212), where k+1 corresponds to the level of the contextual encoder layer within the multi-layer encoder agent 200, may be computed from all messages received at that layer from other encoder agents. In some embodiments, as mentioned above, all encoder agents 200 within the encoder-decoder network 100 share the same structure and, in particular, the same number of layers. In this case, the message vector z^{(k)} provided as input to a given layer at level k+1 may result from messages transmitted by the immediately preceding layers (at level k) of the other encoder agents. For example, the message vector input to the first contextual encoder layer of one encoder agent may be computed from messages conveying the hidden-state output of the local encoder layers of the other encoder agents, and the message vector input to the second contextual encoder layer of one encoder agent may be computed from messages containing the hidden-state output of the first contextual encoder layer of the other encoder agents. Multiple deep intercommunicating encoder agents (where “deep” denotes the presence of multiple stacked layers producing hidden-state output) can, in this manner, encode their respective input sequences across multiple layers, generating new messages at each layer and adapting the encoding of their sequences at the next layer based on the global context as reflected in these messages. The described correspondence between a receiving layer at one level and sending layers at the preceding level need, however, not apply to every embodiment. For example, in alternative embodiments, messages may skip layers between the sending and receiving encoder agents, or messages originating from multiple layers at different levels may be combined at the output of the sending encoder agent or at the input of the receiving encoder agent.

To describe the operation of the encoder agent 200 more formally, consider, as an example, the encoding of a text document d that is decomposed into a sequence of paragraphs xₐ for processing by multiple respective encoding agents a=1, . . . , M, such that, e.g., encoder agent 1 encodes the first paragraph x₁, encoder agent 2 encodes the second paragraph x₂, etc. Each paragraph xₐ={w_{a,i}}^{I}^{ₐ} is a sequence of Iₐ words w_{a,i} (i=1, . . . , Iₐ). Each word w_{a,i} is embedded into an n-dimensional vector e_{a,i}. In the following, all matrices W are projections (i.e., their repeated application to a vector results in the same vector output as a single application to the vector). To simplify notation, the subscript a is hereinafter omitted where possible without causing confusion.

In accordance with some embodiments, e.g., as shown in FIG. 2, the local encoder 202 is implemented by a single-layer bi-directional LSTM, producing the local-encoder hidden-state output hᵢ⁽¹⁾ from the hidden states \vec{h}ᵢ⁽¹⁾, [symbol] that result from processing the input sequence forwards and backwards, respectively. Herein, i=1, . . . , I indicates the index of the token, and all hidden states are H-dimensional real-valued vectors, i.e., hᵢ⁽¹⁾, \vec{h}ᵢ⁽¹⁾, [symbol] ∈ [symbol] ^{H}. The forward and backward hidden states \vec{h}ᵢ⁽¹⁾, [symbol] for each input token i (e.g., word wᵢ) depend on its embedding vector eᵢ, the forward hidden state \vec{h}ᵢ₋₁⁽¹⁾ for the preceding token i−1, and the backward hidden state [symbol] for the following token i+1:

\vec{h}ᵢ⁽¹⁾, [symbol] =bLSTM(eᵢ,\vec{h}ᵢ₋₁⁽¹⁾, [symbol] ).

The local-encoder hidden-state outputs hᵢ⁽¹⁾ are computed by applying a matrix projection to the concatenated forward and backward hidden states \vec{h}ᵢ⁽¹⁾,

[symbol]

hᵢ⁽¹⁾=W₁[\vec{h}ᵢ⁽¹⁾, [symbol] ].

These hidden-state outputs hᵢ⁽¹⁾ of the local encoder 202 are then fed into the contextual encoder 204. The matrix W₁ may, but need not, be shared between agents, depending on the particular network structure and application.

The contextual encoder 204 generates an adapted representation of the agent's encoded information conditioned on the information received from the other agents. In various embodiments, the contextual encoder 204 is implemented by multiple layers of bi-directional LSTMs. At each layer, the contextual encoder 204 jointly encodes the information received from the previous layer (which, for the first layer of the contextual encoder 204, is the output of the local encoder 202). Denoting the hidden-state output and forward and backward hidden states of the k-th contextual encoder layer (i.e., the (k+1)-th layer of the encoder agent, where the local encoder is the first layer) with hᵢ^{(k+1)}, \vec{h}ᵢ^{(k+1)}, [symbol] ∈ [symbol] ^{H} (k=1, . . . , K−1), each cell of the (k+1)-th encoder layer produces a hidden-state output vector hᵢ^{(k+1)} from three types of inputs: the hidden states \vec{h}ᵢ₋₁^{(k+1)} or [symbol] from the adjacent cells, the hidden-state output hᵢ^{(k)} from the previous layer, and the message vector z^{(k)} computed from the output at layer k of the other encoder agents:

\vec{h}ᵢ^{(k+1)}, [symbol] =bLSTM(ƒ(hᵢ^{(k)},z^{k}),\vec{h}ᵢ₋₁^{(k+1)}, [symbol] ).

hᵢ^{(k+1)}=W₂[\vec{h}ᵢ^{(k+1)}, [symbol] ],

where W₂ may, but need not, be shared between agents.

In an encoder with M agents, the message vector zₐ^{k} for agent a may, generally, be a function of any combination of the k-th layer hidden-state output vectors of the other M−1 agents, h_{m,i}^{(k)}(m≠a). In some embodiments, the last hidden-state output vectors, h_{m,l}_{ₘ}^{(k)} (i.e., for each agent m, the hidden-state output vector corresponding to the last token of the input sequence processed by that agent), are averaged over the M−1 other agents to compute the message vector message vector zₐ^{k} for agent a:

$${z}_{a}^{k} = \frac{1}{M - 1} {\sum }_{m \neq a} {h}_{m , {I}_{m}}^{k} .$$

This message-passing scheme is illustrated in FIG. 3 with the example of three communicating encoder agents, labeled a, b, and c. As shown, at the k-th layer 300, encoder agent a generates hidden-state output h_{a,i}^{(k)} in the i-th LSTM cell 302, and receives a message vector zₐ^{k} computed by an averaging operator 304 from the last hidden-state outputs h_{b,I}^{(k)}, h_{c,I}^{(k)} of encoder agents b and c. A function ƒ (308) combines the hidden-state output vector h_{a,i}^{(k)} and message vector zₐ^{k} into input 310 provided to the LSTM cell 312 of the (k+1)-th encoder layer 314. In some embodiments, the function ƒ projects the message vector zₐ^{k} with the agent's previous encoding hᵢ^{(k)} of the input sequence, e.g., in accordance with:

$$f ( {h}_{a , i}^{( k )} , {z}_{a}^{( k )} ) = {v}_{1}^{T} tanh ( {W}_{3} {h}_{a , i}^{( k )} + {W}_{4} {z}_{a}^{( k )} ) .$$

Herein, v₁, W₃, and W₄, are learned network parameters that may (but need not) be shared across all agents. The function ƒ combines the information sent by the other agents with the context of the current token from the paragraph processed by agent a, yielding different features about the current context in relation to other topics in the document d. At each layer, the agent a modifies its representation of its own context relative to the information form other agents, and updates the information it sends to other agents accordingly.

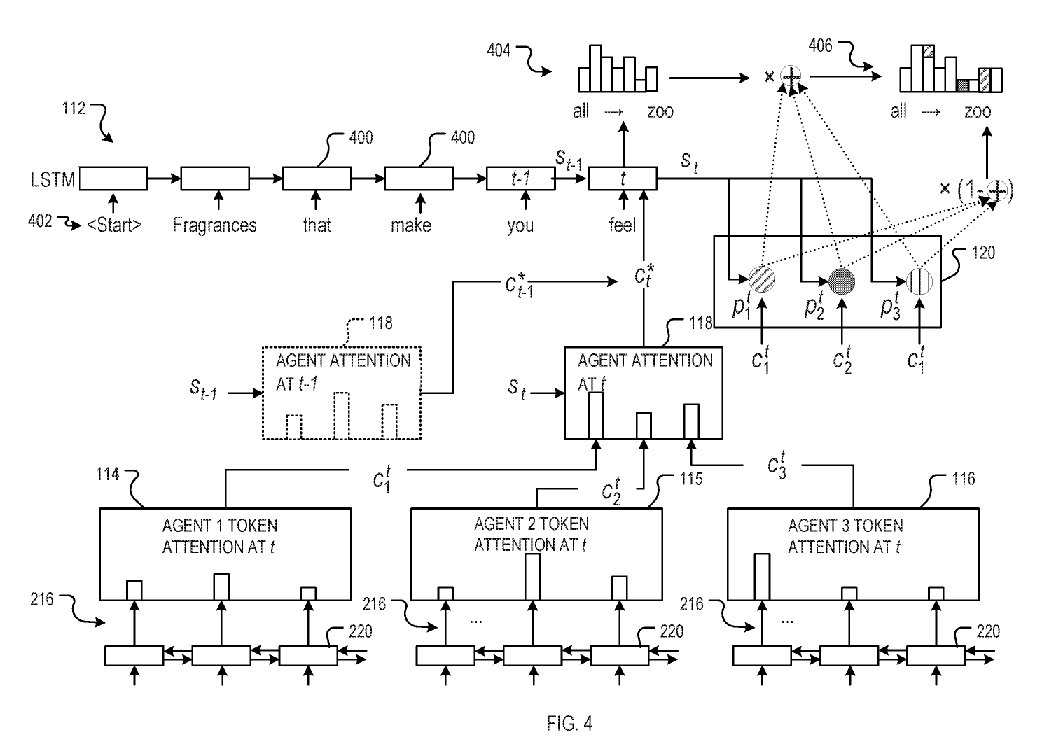

With reference to FIG. 4, an example embodiment of the decoder 112 and associated attention mechanism 110, as may be used, for instance, in an encoder-decoder neural network for abstractive text summarization, is now described in more detail. The decoder 112 may be an RNN, such as, for instance, a single-layer LSTM. In FIG. 4, the LSTM is shown unfolded into cells 400 (only some of which are labeled to avoid cluttering) corresponding to the decoder 112 at different time steps t. In some embodiments, the hidden state of the decoder 112 is initialized to the last top-layer hidden state from the first encoder agent, s₀=h_{1,I}^{(K)}; however, other initializations are also possible. At each time step t, the decoder 112 predicts a new a new token yₜ in the output sequence 402 (e.g., a new word in the summary) and computes a new hidden state sₜ of the decoder 112, taking the previous hidden decoder state sₜ₋₁ and the previously predicted output token yₜ₋₁ (or, during training, the preceding token yₜ₋₁* in the ground-truth output sequence) as input, and further attending to relevant input context provided by the agents, as reflected in the agent context vector cₜ*.

In accordance with various embodiments, the agent context vector cₜ* is computed using a hierarchical attention mechanism 110. First, for each encoder agent a, the associated token-attention network (114, 115, or 116) computes a token attention distribution lₐ^{t} over the top-layer hidden-state output vectors {h_{a,i}^{(K)}}^{I} 216 of that agent. In FIG. 4, only the top layers of three encoder agents are shown, and the token attention distributions are symbolically depicted as bar diagrams within the boxes 114, 115, 116 representing the associated attention networks. In certain embodiments, the token attention distributions are computed according to:

l_{a,i}^{t}=softmax(v₂^{T} tan h(W₅h_{a,i}^{(K)}+W₆sₜ+b₁)).

where lₐ^{t}={l_{a,i}^{t}}^{I}∈[0,1]^{I} is the attention over all tokens in a paragraph xₐ, and where v₂, W₅, W₆ and b₁ are shared learned parameters of the token attention networks 114, 115, 116. Note that the token attention distribution lₐ^{t} is dependent on the decoder state sₜ, and thus different for each decoding time step t, even though the encoder output itself does not change. Using the token attention distributions lₐ^{t}, a new token context vector cₐ^{t} can be computed at each time step t for each agent a as a weighted sum of the top-layer hidden-state output vectors h_{a,i}^{(K)}:

cₐ^{t}=Σᵢ₌₁^{I}l_{a,i}^{t}h_{a,i}^{(K)}.

Each token context vector cₐ^{t} represents the information extracted by the agent a from the input sequence (e.g., paragraph xₐ) it has processed.

The context vectors cₐ^{t} for the plurality of agents are fed as input into the agent-attention network 118 at the second level of the hierarchical attention mechanism 110, which decides, conceptually speaking, which encoder's information is more relevant to the current decoding time step t. This is accomplished by weighting the token context vectors cₐ^{t} with an agent attention distribution g^{t}={gₐ^{t}}^{M}∈[0,1]^{M} that constitutes a soft selection over M encoder agents. The agent attention distribution g t may be computed, for example, according to:

gₐ^{t}=softmax(v₃^{T} tan h(W₇cₐ^{t}+W₈sₜ+b₂)),

where v₃, W₇, W₈ and b₂ are learned parameters of the agent-attention network 118. Like the token attention distributions, the agent attention distribution is computed using the decoder state sₜ as input. Using the agent attention distribution gₐ^{t} and the token context vectors cₐ^{t} of the individual agents, the overall agent context vector cₜ* can be computed as:

cₜ*=Σₐ₌₁^{M}gₐ^{t}cₐ^{t}.

The agent context vector cₜ*∈ [symbol] ^{H} is a fixed-length vector that encodes salient information from the entire document d provided by the agents. Based on this information, along with the decoder state and the previous token of the output sequence, a probability distribution 404 over the vocabulary can be computed for the currently predicted token in the output sequence 402. In accordance with various embodiments, the distribution 404 over the vocabulary, P^{VOC}(yₜ=w|sₜ, yₜ₋₁) (where w is a variable representing the words in the vocabulary), is produced by concatenating the agent context vector cₜ* with the decoder state sₜ, and feeding the concatenated vectors through a linear or nonlinear layer, such as, in some embodiments, a multi-layer perceptron (MLP):

P^{VOC}(yₜ=w|sₜ,yₜ₋₁)=softmax(MLP([sₜ,cₜ*])).

In general, the decoder 112 selects at each time step which agent to attend to. In some embodiments, it is important, however, to prevent the decoder 112 from frequently switching between agents. For example, in the context of text summarization, it may be desirable that the decoder 112 utilize the same agent over the course of a short subsequence, such as a sentence, in order to keep the topic of the generated sentence intact. In accordance with various embodiments, decoder switching between agents is limited by using, in addition to the current agent context vector cₜ*, the agent context vector cₜ₋₁* from the previous time step as input information to the decoding step (an approach that may be referred to as “contextual agent attention”), thereby modifying the distribution over the vocabulary according to:

P^{VOC}(yₜ=w|sₜ,yₜ₋₁)=softmax(MLP([sₜ,cₜ*,cₜ₋₁*])).

The probability distribution 404 is computed over a fixed “basic” vocabulary accessible by the decoder 112. For natural-language-generation task, this basic vocabulary may correspond to the n most common words in a given language. The decoder 112 includes, at its output layer, an output node for each of these n words. To limit the computational cost associated with the prediction of each token in the output sequence, n may be limited, e.g., to on the order of thousands or ten-thousands of words. In text summarization task, the limited basic vocabulary will, in many instances, fail to capture all salient features of the input text. In particular, proper names (e.g., of people and places), which often carry key information of the text, may be out-of-vocabulary. This issue can be addressed by extending the basic vocabulary used to compute the initial distribution 404 with words extracted directly from the input text, and computing an updated probability distribution 406 over the extended vocabulary. For this purpose, the encoder-decoder neural network 100 includes, in accordance with various embodiments, a multi-agent pointer network 120.

The multi-agent pointer network 120 computes at each time step t, for each agent a, a generation probability pₐ^{t}∈[0,1] from the context vector cₐ^{t} and the decoder state sₜ (as indicated in FIG. 4) as well as the predicted output token yₜ, e.g., according to:

pₐ^{t}=σ(v₅^{T}cₐ^{t}+v₆^{T}sₜ+v₇^{T}yₜ+b),

where v₅, v₆^{T}, v₇^{T}, and b are learned parameters (b being a scalar). The generation probability pₐ^{t} determines whether the token value predicted at that time step t is sampled from P^{VOC}(yₜ=w|⋅), or copied from the corresponding agent's input paragraph xₐ by sampling from its attention distribution lₐ^{t}. A probability distribution over the extended vocabulary can be computed for each agent according to:

P^{a}(yₜ=w|⋅=pₐ^{t}P^{VOC}(yₜ=w|⋅)+(1−pₐ^{t})u_{a,w}^{t},

where u_{a,w}^{t} is the sum of the attentions l_{a,i}^{t} over all token indices i where the word w appears in the input paragraph xₐ: u_{a,w}^{t}=Σᵢ with w_{a,i}=w l_{a,i}^{t}. The final probability distribution over the extended vocabulary is obtained as an average of the agents' probability distributions P^{a} (yₜ=w|⋅), each weighted by the respective agent attention gₐ^{t}:

P(yₜ=w|sₜ,yₜ₋₁)=Σₐ₋₁^{M}gₐ^{t}P^{a}(yₜ=w|⋅).

In contrast to a pointer network for a single-agent encoder-decoder network, the multi-agent pointer network 120 allows each agent to “vote” for a different out-of-vocabulary word at time step t, and only the word that is relevant to the generated summary up to time t is collaboratively selected as a result of the agent attentions gₐ^{t}.

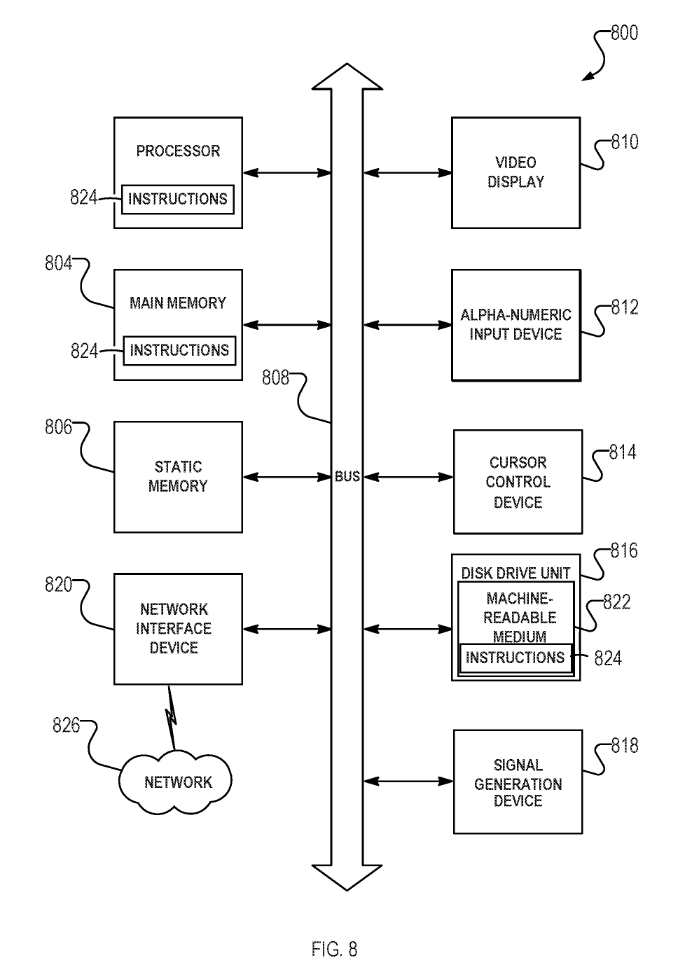

Having described various aspects of a multi-agent encoder-decoder neural-network architecture in accordance herewith, the description now turns, with reference to FIG. 5, to a computing system 500 for implementing, training, and using such a neural-network architecture for sequence-to-sequence mapping tasks. The computing system 500 may generally include any suitable combination of hardware and software, for instance, in accordance with some embodiments, one or more (e.g., general-purpose) computers (e.g., as illustrated in more detail in FIG. 8) that collectively include one or more hardware processors for executing software instructions and one or more machine-readable media storing the instructions as well as the data on which they operate (such as, e.g., the input and output sequences, the weights and parameters of the various components of the encoder-decoder neural network, etc.). The overall functionality of the computing system 500 may be organized into multiple tools, components, or modules. For example, as depicted, the computing system 500 may include, in addition to data and instructions defining the artificial neural network 502 itself, a modeling tool 504, a decoder component 506 (not to be confused with the decoder 112 of the neural network), and a training component 508. Each of these components 502, 504, 506, 508 may be implemented in software, that is, with program code and associated data structures. It is noted that not every embodiment of the disclosed subject matter necessarily includes all of the depicted components. For instance, the neural network 502 (as already trained) and decoder component 506 may be provided as a stand-alone product, separate from the training component 508.

The multi-agent encoder-decoder neural network 502 (corresponding to network 100 and including, for example, one or more types of encoder agents (e.g., 104, 105, 106), a decoder 112, and agent-attention and multi-agent pointer networks 114, 115, 116, 118, 120) is generally defined with a combination of program code and associated data structures that, collectively, cause sequences of input tokens fed into the encoder agents to be processed to generate as sequence of vocabulary distributions for the output tokens. The code and data structures defining the neural network 502 may be directly loaded onto the computing system 500, e.g., in the form of one or more files. Alternatively, the neural network 502 may be defined by a human model developer using the modeling tool 504 to provide, via one or more user interfaces, graphic or textual input 510 regarding the structure of the neural network 502. The input 510 may specify, for instance, the number and types of network layers, the dimensionality of the associated inputs and outputs, the types of network units used within the layers, the activation functions associated with the network nodes or units, the connections between layers, and so on. Based on this input 510, the modeling tool 504 may build program code and associated data structures implementing the neural network 502, for example, from code templates and data-structure templates. The neural network 502 generally includes a number network parameters 511 that need to be trained, as explained further below.

For a given definition and set of parameters 511 of the neural network 502, the decoder component 506 manages the process of generating an output sequence from a given input using the neural network 502. In some embodiments, the decoder component 506 divides the input into a plurality of input sequences and assigns each input sequence to one of the encoder agents. In the case of text input, for instance, the decoder component 506 may split the input into multiple sections or paragraphs, and in the case of multi-modal input, it may partition the input based on modality. In some embodiments, the number of input sequences into which the input is split is dynamically determined, e.g., based on the length of the input, and the decoder component 506 invokes the appropriate number of encoder agents to process the input.

From the vocabulary distributions output by the neural-network decoder 112, the decoder component 506 determines the output sequence. For this purpose, the decoder component 506 may employ a greedy decoding algorithm, which selects, for each token of the output sequence, the most probable label from the probability distribution over the vocabulary (e.g., in embodiments utilizing pointer networks, the extended vocabulary). More generally, the decoder component 506 may employ a beam search algorithm, which iteratively generates a tree structure of possible partial output sequences. In each iteration, the beam search algorithm extends each of a number of previously generated partial output sequences with one additional token, and retains only the b most probable extended partial output sequences, where b is known as the beam width. For a beam width of b=1, the beam search algorithm reduces to greedy decoding. Beam search algorithms are well-known to those of ordinary skill in the art, as are several alternative decoding methods.

The decoder component 506 may be used during the inference (or test) phase to produce output with an already trained network, but may also, in some instances, be employed during training of the neural network 502. When used during the inference phase, the decoder component 506 may receive input 512 and return output 514 via a user interface. A user may, for example, directly enter text (e.g., a question) or upload a text or image file as input 512, and the decoder component 506 may cause the computed output 514 (e.g., an answer to a question, a summary of a text file, or an image caption) to be displayed on-screen or stored for later retrieval. Alternatively, the input 512 may be fed into the decoder component 506 from another computational component (within or outside the computing system 500), and/or the output 514 may be sent to a downstream computational component for further processing. The mode of input and/or output may depend on the particular application context, and other input/output modes may occur to those of ordinary skill in the art. When used during training, the decoder component 506 may receive the input sequence from the training component 508, and return the output sequence predicted by the neural network 502 to the training component 508, e.g., for comparison with the ground-truth output sequence. Alternatively, the training component 508 may duplicate the functionality needed to generate output sequences during network training.

The training component 508 serves to adjust and optimize the network parameters 511 based on training data 516 provided as input to the computing system 500. The training data 516 includes pairs of an input sequence (e.g., a sequence of words for a text, or a sequence of pixels for an image) and an output sequence that constitutes the ground-truth output for the input. The type and data format of the input and output sequences depends on the specific application for which the neural network 502 is to be trained. For abstractive summarization, for instance, the input sequences may be longer texts, and the corresponding output sequences may be human-generated text sequences. As another example, for image captioning, the input sequences are images, and the output sequences may be human-generated image captions.

To train the neural network 502, multiple approaches may be employed (individually or in combination). In general, training the neural network 502 involves minimizing one or more losses designed to achieve one or more corresponding training objectives. One such training objective is to maximize the likelihood that neural network 502 produces the ground-truth output sequence of the training example. Denoting the input sequence with d and the ground-truth output sequence with y*={y₁*, y₂*, . . . , y_{T}*}, the maximum-likelihood-estimation (MLE) loss is given by:

L_{MLE}=−Σₜ₌₁^{T} log p(yₜ*|y₁* . . . yₜ₋₁*,d).

Note that this negative log-likelihood of the target output sequence (that is, the ground-truth sequence) is a positive term that is minimal when the probability of the target output sequence is maximized. The MLE loss can be minimized by gradient descent optimization using backward propagation of errors, a technique well-known to those of ordinary skill in the art. Note that, when the neural network 502 is used to compute the probability of the ground-truth sequence, the labels of that sequence (rather than labels sampled from the output probability distribution) are fed as input into the decoder 112.

Alternatively or additionally to MLE training, the neural network 502 may be trained by reinforcement learning (RL). In this approach, one or more task-specific metrics are used to quantify the quality of a predicted output sequence as compared with the input sequence. To evaluate automatically generated text summaries or other natural-language output, for instance, ROGUE (Recall-Oriented Understudy for Gisting Evaluation) metrics are commonly used. ROGUE metrics capture the difference between predicted and ground-truth text sequences, for example, in terms of the overlap in N-grams, longest-common-subsequence-based statistics, and skip-bigram-based co-occurrence statistics. These or other metrics may be used to compute, for any output sequence ŷ generated by the network, a corresponding reward r(ŷ). The training objective then becomes to maximize the expected rewards, e.g., summed over all training examples or, in batch training, over all training examples within a batch. For non-differentiable metrics, such as ROGUE metrics, the expected reward cannot be directly maximized using backpropagation. However, the gradient, with respect to the network parameters, of the expectation of the reward can be rewritten as the expectation of the reward multiplied by the logarithm of the probability of the respective output sequence, which, in turn, can be approximated by a one-sample estimate (known as a reinforcement gradient estimator), corresponding to a loss function (prior to taking the gradient) of

−r(ŷ)Σₜ₌₁^{T} log p(ŷₜ|ŷ₁ . . . ŷₜ₋₁,d).

In accordance with various embodiments, a self-critical training approach is used to explore new output sequences and compare them to the greedily decoded output sequence. For each training-example input d, two output sequences are generated: one sequence ŷ is sampled from the probability distribution p(ŷₜ|ŷ₁ . . . ŷₜ₋₁, d) at each time step t, and another sequence \tilde{y} is the baseline output greedily generated by argmax decoding from p(\tilde{y}ₜ|\tilde{y}₁ . . . \tilde{y}ₜ₋₁,d). The training objective is then to minimize the RL loss:

L_{RL}=(r(\tilde{y})−r(ŷ))Σₜ₌₁^{T} log p(ŷₜ|ŷ₁ . . . ŷₜ₋₁,d).

This reinforcement loss, which measures the advantage of the sampled over the greedily decoded sequences, ensures that, with better exploration, the neural network 502 learns to generate sequences \tilde{y} that receive higher rewards than the baseline \tilde{y}, increasing overall reward expectation.

In some embodiments, the computation of the RL loss utilizes, instead of end-of-summary rewards, intermediate, sentence-based rewards to promote generating diverse sentences. Rather than rewarding sentences based on the scores obtained at the end of the generated summary, incremental ROUGE scores are computed for each generated sentence:

r(ô_{q})=r([ô₁, . . . ,ô_{q}])−r([ô₁, . . . ,ô_{q-1}]).

With such incremental ROUGE scores, sentences are rewarded for the increase in ROUGE that they contribute to the full summary, ensuring that the current sentence contributes novel information to the overall summary.

In various embodiments, additional task-specific losses may be employed. For example, to encourage sentences in a summary that are informative without repetition, a semantic-cohesion loss may be defined. To compute this loss, as the output sequence {y₁, y₂, . . . , y_{T}} is generated, the training component 508 may keep track of the indices of the end-of-sentence delimiter token (“.”). The decoder hidden-state vectors at the end of each sentence, S′_{q}, q=1 . . . Q, where S′_{q}∈{sₜ: yₜ=“.”, 1≤t≤T}, can then be used to compute the cosine similarity between two consecutively generated sentences. The resulting semantic-cohesion loss to be minimized is:

L_{SEM}=Σ_{q=2}^{Q} cos(s′_{q},s′_{q-1}).

In various embodiments, the neural network 502 is trained with a mixed training objective including multiple loss terms. For example, MLE and semantic-cohesion losses may be combined according to:

L_{MLE-SEM}=L_{MLE}+λL_{SEM},

where λ is a tunable hyperparameter. Further, MLE and RL losses may be combined in a weighted average:

L_{MIXED}=γL_{RL}+(1−γ)L_{MLE},

where γ is a tunable hyperparameter. While training with only MLE loss may learn a better language model, this may not guarantee better results on discrete performance measures (such as ROUGE metrics). Conversely, optimizing with only RL loss may increase the reward gathered at the expense of diminished readability and fluency of a generated summary. The above mixed loss balances the two objects, which can yield improved task-specific scores while maintain a good language model that generates readable, fluent output. Further improvements may be achieved, in accordance with some embodiments, by adding in the semantic-cohesion loss:

L_{MIXED-SEM}=γL_{RL}+(1−γ)L_{MLE-SEM}.

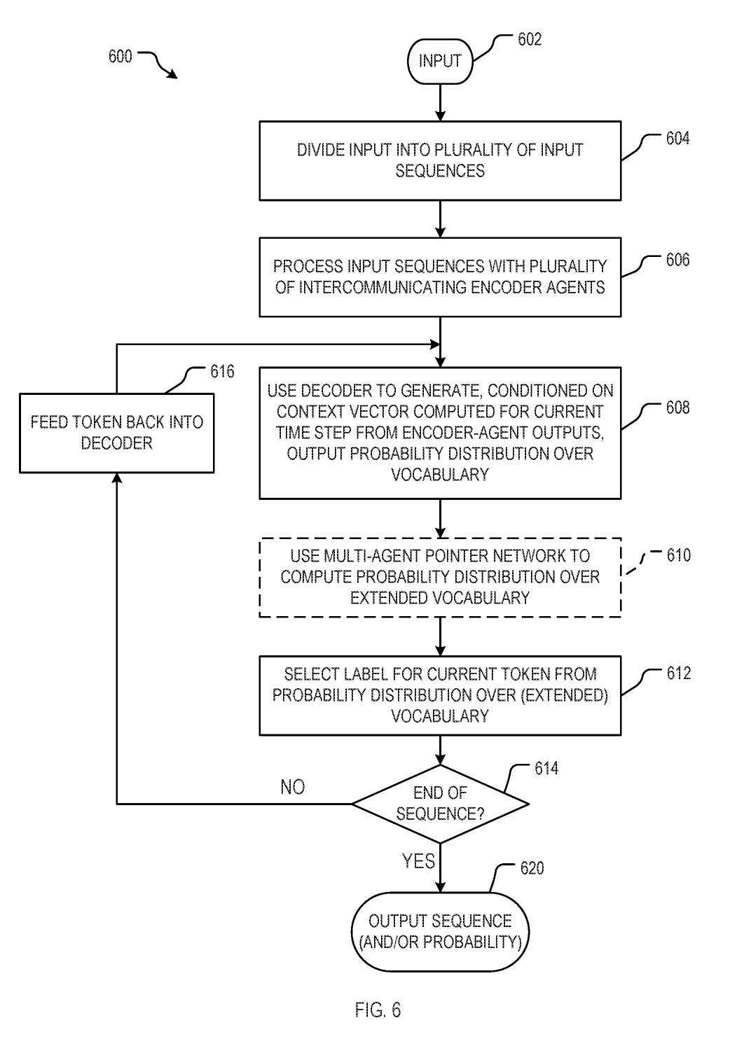

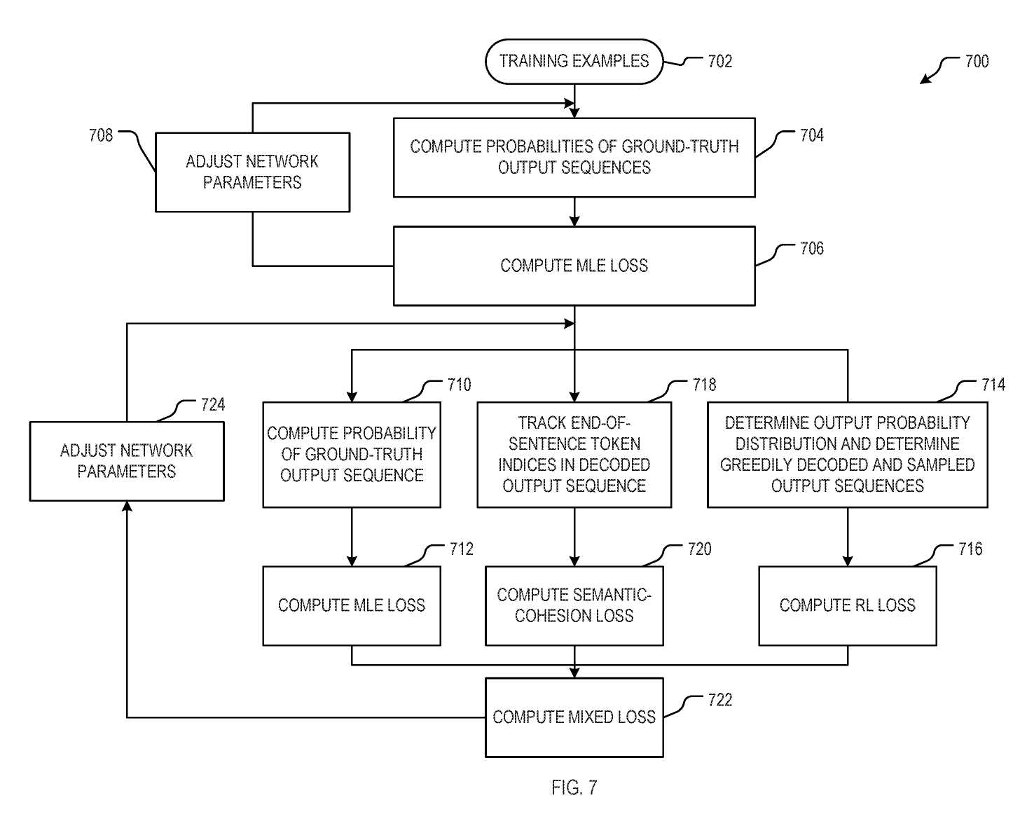

Turning now to FIGS. 6 and 7, methods for using and training an encoder-decoder neural network 100, 502 are illustrated. These methods may be performed, e.g., using the computing system 500. With reference to FIG. 6, a method 600, applicable to both the training phase and the inference phase, for using an encoder-decoder neural network in accordance with various embodiments to map an input sequence to an output sequence is shown. Given an input 602, the method 600 begins, in act 604, with dividing the input 600 into a plurality of input sequences. These input sequences are then, in act 606, processed with a plurality of multi-layer encoder agents (104, 105, 106, 200), one for each of the input sequences; the encoder agents communicate with one another by exchanging message vectors computed from hidden-state output vectors computed at the various layers of the agents.

Following the encoding of the input sequences, in act 608, the neural-network decoder 112 sequentially generates, for each token of the output sequence, an output probability distribution over a vocabulary; the decoder 112 is conditioned on a context vector computed for the current time step from the (top-layer) encoder-agent outputs. Optionally, in some embodiments, a multi-agent pointer network is used, in act 610, to compute an output probability distribution over an extended vocabulary. This extended vocabulary corresponds to a weighted average of agent-specific output probability distributions, each agent-specific output probability distribution itself being a weighted average of the output probability distribution over the basic vocabulary computed in act 608 and a probability distribution over a vocabulary extension derived from the input sequence processed by the respective encoder agent. From the output probability distribution (over the vocabulary or extended vocabulary, as the case may be), a label for the current token of the output sequence is selected in act 612. In the case of greedy decoding, the selected label is the one having the greatest associated probability in the probability distribution. In a beam search, multiple values are selected to (temporarily) retain multiple possible partial output sequences. In the context of self-critical reinforcement learning, in addition to the greedily decoded label, a second output label is sampled from the probability distribution. In MLE training, the label of the respective ground-truth token is chosen to determine its associated probability. In the cases where multiple labels are selected, the method 600 multifurcates at this point into respective branches (not shown).

In act 614, it is determined (for each of the branches, if applicable), whether the selected label is the end-of-sequence symbol. If not, the selected label of the output token is fed back into the decoder 112 in act 616, and the decoder 112 then proceeds to compute the output probability distribution for the next token. The generation of output probability distributions and selection of labels therefrom repeats in a loop until the end of the sequence is reached. The output sequence and/or associated probability (or multiple output sequences and probabilities), collectively 620, are then returned. In the case of a beam search (with width b>1), the most probable of all computed output sequences can be selected as the final output.

FIG. 7 is a flow chart of an example method 700 for training an encoder-decoder neural network 100, 502. In accordance with various embodiments, the neural network 100, 502 is trained end-to-end, i.e., the network parameters of the encoder agents, decoder, attention networks, and, if applicable, pointer network are all optimized jointly based on a shared loss function. The method 700 takes a set of training examples 702, each including an input sequence and an associated output sequence, as input. In some embodiments, as shown, the neural network 100, 502 is pre-trained based on MLE loss only. This pre-training stage involves iteratively computing the probabilities of the ground-truth output sequences from the respective input sequence for all training examples (act 704), computing the MLE loss aggregated or averaged across all training examples (act 706), and adjusting the network parameters 510 in the direction of decreasing MLE loss (act 708).

Once good starting values for the network parameters 510 have been determined (e.g., after a specified number of pre-training iterations, or when a specified convergence criterion is satisfied), the training switches over to a mixed training objective, e.g., as shown, combining MLE, semantic-cohesion, and RL losses. As before, for each training example, the probability of the ground-truth output sequence y* (as determined in act 710) is used to compute the respective MLE loss (act 712). For self-critical reinforcement learning, as described above, a greedily decoded output sequence \tilde{y} and an output sequence ŷ sampled from the sequence of output probability distributions are determined (act 714), and the RL loss is then computed as an advantage function measuring the difference in the rewards (e.g., as based on ROUGE or other task-specific metrics) between the two output sequences (act 716). In embodiments that additionally use a semantic-cohesion loss, the indices of output tokens taking the end-of-sentence symbol as their values are tracked in the output sequence ŷ decoded by sampling from the output probability (act 718), and the cohesion loss is computed based on the similarity between consecutive sentences (act 720). (If a self-critical RL loss is not used, the cohesion loss may be determined from a greedily decoded output sequence.) The individual loss terms are then combined into a mixed loss (act 722), such as the L_{MIXED} or L_{MIXED-SEM} losses defined above. Further loss terms corresponding to additional criteria or objectives may occur to those of ordinary skill in the art, and may be integrated into the mixed loss. The network parameters 510 are then iteratively adjusted (act 724) to minimize the mixed loss, either sequentially for the individual training examples, or jointly for all examples or all examples within a batch.

The multi-agent encoder-decoder neural network described herein, and the associated systems and methods for training and inference, are generally applicable to a wide range of sequence-to-sequence mapping tasks, including, without limitation, the creation of natural-language sequences based on a variety of types of input, as well as the generation of sequences of control actions taken by a control system of a machine or group of machines (such as robots, industrial machinery, or vehicles) based on sensor or other input. In the realm of natural-language processing, example tasks include abstractive summarization based on text or spoken-language input (e.g., in an audio recording), image captioning (which may also be viewed as summarization based on visual input), and answer-generation based on an input question or search. Beneficially, the multi-agent approach described herein, by splitting up the input into multiple sequences for encoding, allows for the processing of long-form input (e.g., text input including more than 800 words, which has been a performance limit in prior approaches) as well as the generation of long-form output (e.g., multi-sentence summaries, and/or summaries with more than 100 words).

In general, the operations, algorithms, and methods described herein may be implemented in any suitable combination of software, hardware, and/or firmware, and the provided functionality may be grouped into a number of components, modules, or mechanisms. Modules and components can constitute either software components (e.g., code embodied on a non-transitory machine-readable medium) or hardware-implemented components. A hardware-implemented component is a tangible unit capable of performing certain operations and can be configured or arranged in a certain manner. In example embodiments, one or more computer systems (e.g., a standalone, client, or server computer system) or one or more processors can be configured by software (e.g., an application or application portion) as a hardware-implemented component that operates to perform certain operations as described herein.

In various embodiments, a hardware-implemented component can be implemented mechanically or electronically. For example, a hardware-implemented component can comprise dedicated circuitry or logic that is permanently configured (e.g., as a special-purpose processor, such as a field programmable gate array (FPGA) or an application-specific integrated circuit (ASIC)) to perform certain operations. A hardware-implemented component can also comprise programmable logic or circuitry (e.g., as encompassed within a general-purpose processor or other programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) can be driven by cost and time considerations.

Accordingly, the term “hardware-implemented component” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a general-purpose processor configured using software, the general-purpose processor can be configured as respective different hardware-implemented components at different times. Software can accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components can be regarded as being communicatively coupled. Where multiple such hardware-implemented components exist contemporaneously, communications can be achieved through signal transmission (e.g., over appropriate circuits and buses that connect the hardware-implemented components). In embodiments in which multiple hardware-implemented components are configured or instantiated at different times, communications between such hardware-implemented components can be achieved, for example, through the storage and retrieval of information in memory structures to which the multiple hardware-implemented components have access. For example, one hardware-implemented component can perform an operation and store the output of that operation in a memory device to which it is communicatively coupled. A further hardware-implemented component can then, at a later time, access the memory device to retrieve and process the stored output. Hardware-implemented components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions. The components referred to herein can, in some example embodiments, comprise processor-implemented components.

Similarly, the methods described herein can be at least partially processor-implemented. For example, at least some of the operations of a method can be performed by one of processors or processor-implemented components. The performance of certain of the operations can be distributed among the one or more processors, not only residing within a single machine, but deployed across a number of machines. In some example embodiments, the processor or processors can be located in a single location (e.g., within an office environment, or a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs)).

Example embodiments can be implemented in digital electronic circuitry, in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of description language, including compiled or interpreted languages, and it can be deployed in any form, including as a standalone program or as a component, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

FIG. 8 is a block diagram of a machine in the example form of a computer system 800 within which instructions 824 may be executed to cause the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 1302 (e.g., a central processing unit (CPU), a graphics processing unit (GPU), or both), a main memory 804, and a static memory 806, which communicate with each other via a bus 808. The computer system 800 can further include a video display 810 (e.g., a liquid crystal display (LCD) or a cathode ray tube (CRT)). The computer system 800 also includes an alpha-numeric input device 812 (e.g., a keyboard or a touch-sensitive display screen), a user interface (UI) navigation (or cursor control) device 814 (e.g., a mouse), a disk drive unit 816, a signal generation device 818 (e.g., a speaker), and a network interface device 820.

The disk drive unit 816 includes a machine-readable medium 822 on which are stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, with the main memory 804 and the processor 802 also constituting machine-readable media.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 824 can be transmitted or received over a communication network 826 using a transmission medium. The instructions 824 can be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

What is claimed is:

1. A computer-implemented method comprising:
using one or more hardware processors executing instructions stored in one or more machine-readable media to perform operations comprising:
dividing input into a plurality of input sequences;
processing the plurality of input sequences with a plurality of respective multi-layer neural-network encoder agents to compute a plurality of respective sequences of top-layer hidden-state output vectors, each encoder agent taking, as input to at least one of its layers, a respective message vector computed from hidden-state output vectors of the other ones of the plurality of encoder agents; and
using a neural-network decoder to generate a sequence of output probability distributions over a vocabulary, the neural-network decoder being conditioned on an agent context vector comprising a weighted average of token context vectors for the plurality of encoder agents, the token context vector for each of the encoder agents comprising a weighted average of the top-level hidden-state output vectors computed by that encoder agent, weights in the weighted averages of the token context vectors and the agent context vector being dependent on a hidden state of the neural-network decoder.

2. The method of claim 1, wherein the vocabulary comprises a basic vocabulary and a vocabulary extension derived from the input, and wherein the output probability distributions are weighted averages of agent-specific output probability distributions, each agent-specific output probability distributions being a weighted average of a probability distribution over the basic vocabulary and a probability distribution over a portion of the extension derived from the input sequence processed by the respective encoder agent.

3. The method of claim 1, wherein the weights in the weighted averages of the token context vectors are token attention distributions computed from the top-layer hidden-state output vectors of the respective encoder agents, and wherein the weights in the weighted average of the agent context vector are agent attention distributions computed from the token context vectors.

4. The method of claim 1, wherein each encoder agent comprises a local encoder and a multi-layer contextual encoder, the method comprising feeding hidden-state output vectors of the local encoder as input to a first layer of the contextual encoder, feeding hidden-state output vectors of each except the last layer of the contextual encoder as input to the next layer of the contextual encoder, and providing, as input to each layer of the contextual encoder, a message vector computed from at least one of the hidden-state output vectors of layers of the contextual encoders of the other encoder agents.

5. The method of claim 4, wherein the local encoders and the layers of the contextual encoders of the plurality of encoder agents each comprise a bi-directional long short-term memory network.

6. The method of claim 1, wherein the neural-network decoder comprises a long short-term memory network.

7. The method of claim of claim 1, wherein the input represents a human-language input sequence and the plurality of input sequences represent subsequences collectively constituting the human-language input sequence, the method further comprising generating a summary of the text from the sequence of output probability distributions over the vocabulary.

8. The method of claim 1, wherein the input is multimodal and is divided into the input sequences by input modality.

9. A system comprising:
one or more hardware processors; and
memory storing (i) data and program code collectively defining an encoder-decoder neural network, and (ii) program code which, when executed by the one or more hardware processors, causes the encoder-decoder neural network to be trained based on a mixed training objective comprising a plurality of loss terms,
wherein the encoder-decoder neural network comprises:
a plurality of intercommunicating multi-layer encoder agents, each encoder agent taking, as input to one or more of its layers, one or more respective message vectors computed from hidden-state output of the other ones of the plurality of encoder agents;
a decoder comprising a recurrent neural network taking, as input at each time step, a respective current decoder state and a context vector computed from top-layer hidden-state outputs of the plurality of encoder agents.

10. The system of claim 9, wherein the plurality of loss terms comprises a maximum-likelihood-estimation term and a semantic-cohesion loss term.

11. The system of claim 9, wherein the plurality of loss terms comprises a maximum-likelihood-estimation term and a reinforcement-learning loss term.

12. The system of claim 9, wherein the program code causing the network to be trained comprises instructions to adjust parameters of the encoder-decoder neural network to maximize a likelihood associated with one or more training examples, and thereafter to further adjust the parameters of the encoder-decoder neural network using self-critical reinforcement learning.

13. The system of claim 12, wherein the reinforcement-learning loss term comprises intermediate rewards.

14. The system of claim 9, wherein the context vector computed from top-layer hidden-state outputs of the plurality of encoder agents comprises a weighted average of token context vectors for the plurality of encoder agents, the token context vector for each of the encoder agents comprising a weighted average of vectors constituting the top-level hidden-state output computed by that encoder agent, weights in the weighted averages of the token context vector and the context vector being dependent on a hidden state of the recurrent neural network.

15. The system of claim 9, wherein the decoder is configured to generate a sequence of output probability distributions over a vocabulary.

16. The system of claim 9, wherein the vocabulary comprises a basic vocabulary and a vocabulary extension derived from input to the encoder-decoder neural network, and wherein the output probability distributions are weighted averages of agent-specific output probability distributions, each agent-specific output probability distributions being a weighted average of a probability distribution over the basic vocabulary and a probability distribution over a portion of the extension derived from a portion of the input to the encoder-decoder neural network to be processed by the respective encoder agent.

17. One or more machine-readable media storing:
data defining a trained encoder-decoder neural network, the encoder-decoder neural network comprising:
a plurality of intercommunicating multi-layer encoder agents, each encoder agent taking, as input to one or more of its layers, one or more respective message vectors computed from hidden-state output of the other ones of the plurality of encoder agents, and
a decoder comprising a recurrent neural network taking, as input at each time step, a respective current decoder state and a context vector computed from top-layer hidden-state outputs of the plurality of encoder agents; and
instructions for execution by one or more hardware processors, the instructions, when executed by the one or more hardware processors, causing the one or more hardware processors to perform operations for generating text output from input to the encoder-decoder neural network, the operations comprising:
dividing the input to the encoder-decoder neural network into a plurality of input sequences,
feeding the plurality of input sequences into the plurality of encoder agents,
using the plurality of encoder agents to encode the input to the encoder-decoder neural network by the top-layer hidden-state output of the plurality of decoder agents, and
using the decoder, greedily decoding the encoded input to the encoder-decoder neural network to generate a sequence of words selected from a vocabulary, the sequence of words constituting the text output.

18. The one or more machine-readable media of claim 17, wherein the input to the encoder-decoder neural network is human-language input.

19. The one or more machine-readable media of claim 18, wherein the input to the encoder-decoder neural network is text input and the input sequences are text sections collectively constituting the text input, and wherein the encoder-decoder neural network is trained to generate, as the text output, a summary of the text input.

20. The one or more machine-readable media of claim 19, wherein the vocabulary comprises a basic vocabulary and a vocabulary extension derived from the text input to the encoder-decoder neural network, and wherein the output probability distributions are weighted averages of agent-specific output probability distributions, each agent-specific output probability distributions being a weighted average of a probability distribution over the basic vocabulary and a probability distribution over a portion of the extension derived from text section processed by the respective encoder agent.
